(19) United States
(12) Patent Application Publication
(10) Pub. No.: US 2003/0167316 A1
(43) Pub. Date: Sep. 4, 2003

(54) Data storage service for users of data communication networks

(76) Inventors: Arnold H. Bramnick, Boca Raton, FL (US); Mark A. Sehorne, Round Rock, FL (US)

Correspondence Address: IBM Corporation, Intellectual Property Law, Internal Zip 4042, 8051 Congress Avenue, Boca Raton, FL, 33487, US

(21) Appl. No.: 10/086,390

(22) Filed: Mar. 1, 2002

(51) Int. Cl. G06F 15/16

(52) U.S. Cl. 709/219; 709/203

(57) ABSTRACT

The presently contemplated file transfer service, for users of data communication networks like the Internet, operates as agent of respective subscribing clients to retrieve and store data files that clients are unable to instantly download to workstations currently used by them. Files stored by the transfer service are made available to respective clients when the latter are able to receive them. In one application of this, a client is unable to instantly download a large file because the computer workstation the client is then using operates at a low speed unsuited for that purpose. In other applications, the client is unable to download a file because the client's workstation is behind a firewall that effectively blocks that action. In these applications, the transfer service is useful to effectively either circumvent restrictions of the firewall, or to deliver the file to the client at a workstation that is not behind the firewall. The contemplated service retrieves and stores data files at source locations designated by client workstations, and confirms completion of these operations to the client (e.g. via an e-mail message). When the client is at a workstation able to receive files stored by the service, the client connects to the service and requests transmittal of respective files. Upon authenticating the client's identity and subscription, the transfer service makes the file accessible to the requesting client. A group of clients may use a single subscription to effectively allow any member of the group to initiate a file retrieval and storage operation and/or to request access to a previously retrieved and stored file.

### BACKGROUND OF THE INVENTION

This invention relates to a service for users of high speed links to data communication networks such as the Internet. These users may need to download data files from a remote location on the network, but are unable to do so because of conditions existing at their workstations making it either impractical or impossible to directly download data from remote sources to respective workstations. In such circumstances, the presently contemplated service is useful to retrieve and store data files from remote sources designated by its clients, and to make the stored data available to its clients when conditions at respective client workstations do not prevent receipt of data from the service.

### SUMMARY OF THE INVENTION

In one application of the invention, a client of the file transfer service presently contemplated has workstations operating at different speeds relative to a network (e.g. the Internet) connecting to the service. While using the slow workstation (e.g. while on a business trip and using a slow laptop computer with a conventional dial-up modem), the client locates a data file too large for practical direct retrieval at that workstation, and requests the service to retrieve and store the file. The request identifies the location of the file source on the network, and the service—acting as agent for the client—retrieves and stores the file for the client, and sends confirmation to the client, e.g. via e-mail. Later, while using the fast workstation (e.g. a desktop computer with broadband cable or DSL connection to the same network), the client connects to the transfer service and requests that the stored file be forwarded. In response to the latter request, the service transmits the stored file to the client's workstation at a transmission speed at which the transfer is accomplished in a practical interval of time.

In other applications, the client uses the service to effectively overcome security restrictions preventing transfer of data to a client workstation from an arbitrary remote source.

In one such application, both client workstation(s) and a transfer server operated by the transfer service (which, in this case, could be a facility controlled by the client's employer) are behind a firewall restricting transmission of data from arbitrary sources on a network to the workstation(s). In this instance, the firewall is programmed to allow the transfer server to download data from arbitrary sources on the external network. Thus, the client can use the transfer server to retrieve and store data that could not be transmitted directly to the client's workstation(s). The transfer server can be programmed to inspect retrieved data for viruses or other problems (e.g. relevance to a business enterprise maintaining that server and the firewall) and discard data which is considered flawed or unsuitable.

In a similar application, a client workstation is behind the firewall and the transfer server and remote source of data are both outside the firewall. In this situation, the firewall prevents direct transfer of data from the remote source to the client workstation, but allows transfer of data from the transfer server to the client. Accordingly, if the client locates a remote source of data that can not be sent through the firewall, the client workstation sends a request to the (external) transfer server and the latter operates to effectively bypass the firewall.

More specific applications of the foregoing security circumvention use are as follows:

Associated clients A and B are located behind a firewall, and the transfer server is located outside of the firewall (on the internet for example). The associated clients may be a single client having two workstations behind the firewall or two different clients having a sharing association relative to data retrievable by the transfer server. The firewall is programmed to permit transmission of file retrieval requests from either client to the transfer server, and to deny transmission of such requests to any other computer outside the firewall. The firewall also is programmed to allow the transfer server to transmit acknowledgments and data to either client. Now assume client A locates a file or files that he wants to download from a source outside the firewall. Since the firewall will not permit a direct transfer, client A, using the aforementioned plug-in, makes a request to the transfer server to retrieve the desired files. The transfer server schedules retrieval of the specified files, stores the retrieved files, and notifies either client when these functions have been completed. Thereafter, upon receipt of a file transfer request from either client, the transfer server transmits the stored file to the workstation issuing that request.

In the other application, associated clients A and B and the transfer server are all behind the firewall. The firewall is programmed to permit transmission of file retrieval/transfer requests between the transfer server and any source on the external networks (e.g. the internet), and to deny transmissions of similar requests between the clients external sources. The firewall allows transmissions of browsing requests between the clients and external sources. Now assume client A locates a file (or files) that he wishes to download from outside the firewall. Since the firewall will not permit a direct transfer, client A, using the aforementioned plug-in, makes a request to the transfer server to retrieve the desired files. The transfer server then schedules the file transfer, stores the retrieved files and, upon completing these functions, notifies client A (or B) that the file or files has been retrieved. Client A (or B) then sends a transfer request to the transfer server and the latter transmits the stored data to the requesting workstation.

In a third application of these security restriction avoidance uses, workstations A and B used by the same person/client are located respectively outside the firewall and inside the firewall (e.g. A at the client's home and B at the client's workplace), and the transfer server is situated inside the firewall. In this instance, while using (external) workstation A, the client locates a remote source of data that the client wants downloaded to (inside) workstation B. The firewall, which prevents direct downloading of that data from its source to workstation B, is programmed to allow communications from any external source to the transfer server. Accordingly, workstation A is operated to request the transfer server to retrieve the data from the remote source. The server retrieves and stores the file and confirms completion of that to workstation A. The file is later retrieved at workstation B; via either secure or unsecured communications between it and the transfer server as permitted or required by the enterprise operating the firewall (e.g. the client's employer).

In yet another application of the invention, wherein neither the speed of a client workstation nor the existence of a firewall prevents direct downloading of data to a client workstations, but the workstation currently is too busy with tasks more important than the direct download, the client could use the contemplated transfer service to perform data retrieval and storage functions so as to present minimal interference to the more important tasks currently being handled. Then, when the workstation is less busy, and the transfer service has acknowledged retrieval and storage of the requested file(s), the client may operate the workstation to request transfer of the stored file(s) and receive them from the transfer service.

In other aspects of the invention's use, a single subscription to the service could be shared by multiple clients; e.g. to enable any member of the sharing group to have data transferred from a remote source to any other member of the group.

In any of the foregoing applications wherein the remote source is accessible through the Internet, the location of that source can be identified to the transfer server either as the actual URL (Uniform Resource Locator) of the data location per se, or as a URL address of a page containing a hyperlink to the data's actual location. If the latter page contains plural hyperlinks to retrievable files, the transfer server retrieves and stores all such files on behalf of the client, enabling the latter to retrieve any one or all of the linked files.

In using the presently contemplated service via the Internet, the client's workstation (e.g. a computer system or other Internet access device) runs a service program provided by the service operator, such as a Java Applet or a plug-in to the subscriber's Internet browser. The service program links to the transfer server, identifies the client and interacts with the client and the server to transmit to the server a request to retrieve and store a file at a specified remote location. The server performs that function and confirms its completion to the client. The client's workstation (either the same one or another one) thereafter links to the server and the service program transmits a request to have a previously retrieved and stored file forwarded to the client. It is understood that a request to retrieve and store data is different (e.g. in form and content) from a request to forward the same data.

Requests are queued at the transfer server and executed there at a pace convenient for the server and consistent with the speed of its connection to the client. Typically, the service program is configured to run concurrent with the client's Internet browser application so that processes associated with the service program present minimal interference to other processes instantly occupying respective client workstations.

The foregoing and other aspects, features and benefits of this invention will be better understood by considering the following detailed description and claims.

### BRIEF DESCRIPTION OF DRAWINGS

FIG. 1 is a schematic indicating how a subscriber/client typically would use the presently contemplated file transfer service.

FIG. 2 is a flowchart indicating processes of interaction between a client and the presently contemplated transfer service.

FIG. 3 is a schematic block diagram illustrating application of the invention in a network environment wherein communications between the client and network are restricted by a firewall that is effectively bypassed by the transfer service.

FIG. 4 is a schematic block diagram illustrating application of the invention in a network environment wherein a first workstation operated by the client is behind a firewall restricting communications relative to a network and the transfer service and a second workstation operated by the same client are situated outside the firewall.

FIG. 5 is a schematic block diagram illustrating application of the invention in a network environment wherein the transfer service is situated behind a firewall, a first workstation operated by a client is outside the firewall, and a second workstation operated by the same client is behind the firewall.

### DETAILED DESCRIPTION

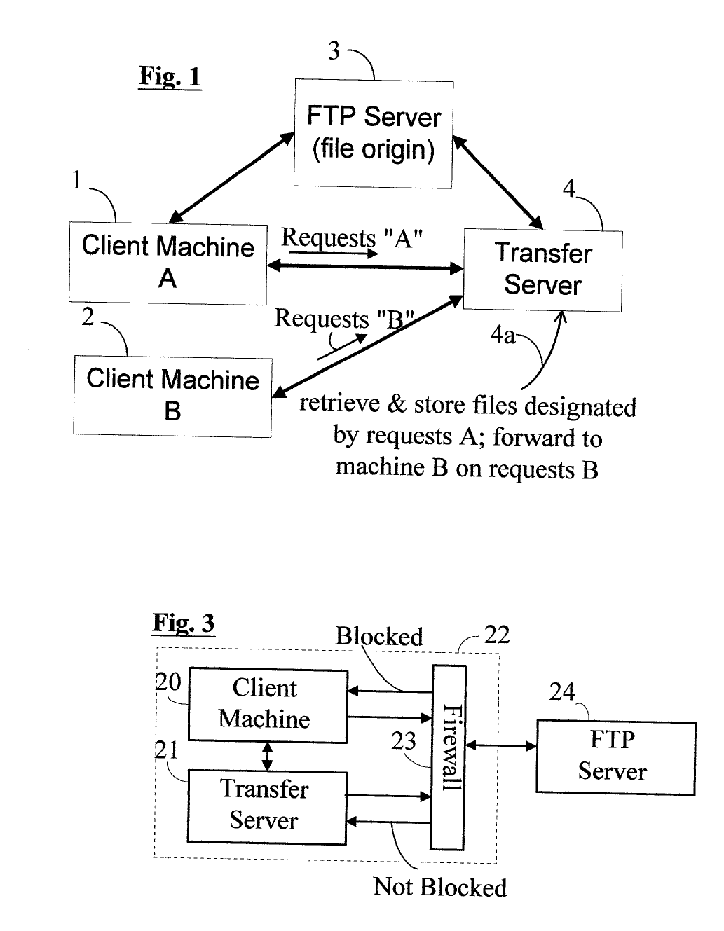

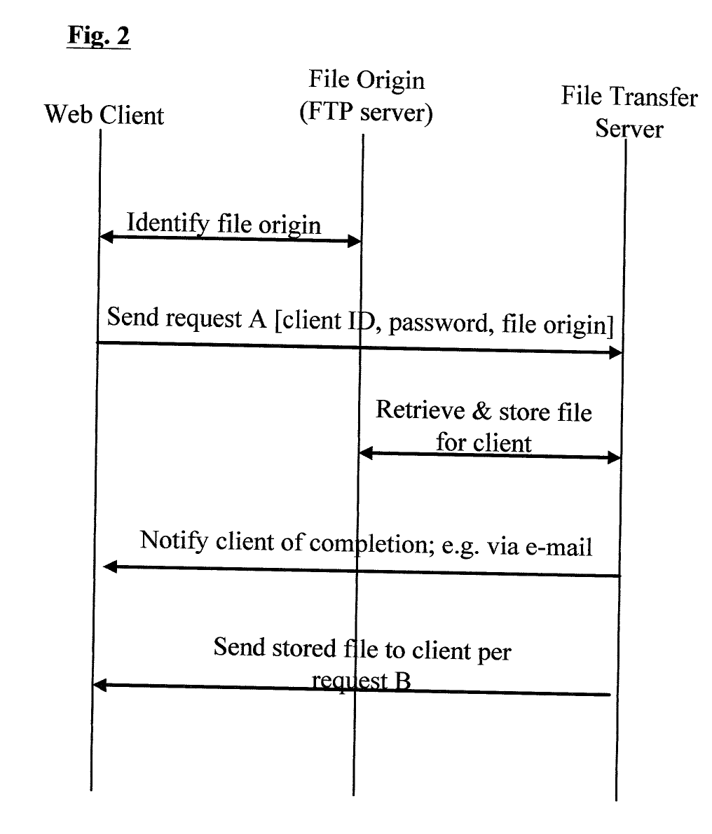

The block diagram in FIG. 1 shows connections between client machines and a file transfer server, and FIG. 2 shows message flows over these connections in accordance with the invention.

Referring to FIGS. 1 and 2, machine A at 1 represents a terminal used by a client of the contemplated service to surf the web, and machine B at 2 represents a terminal used by the same client (or an associate) to access files previously retrieved and stored by the contemplated service. Typically, machine B operates faster than machine A, and the contemplated service is used to retrieve and store large files found by a client using machine A. However, the contemplated service may be useful even if machines A and B operate at the same speed; typically, when a client using machine A needs to avoid interfering with other computing and communication processes currently being performed at that machine. In fact, as noted previously, machines A and B could be a single workstation having a high communication speed, and use the contemplated service simply to avoid blocking processes more time-urgent than those involved in downloading large files found on the web.

In surfing the web, machine A locates a large file of possible interest at a remote source; typically, at an FTP server 3 (i.e. a server using the well-known File Transfer Protocol of the internet). Responding to actions by its user as the latter surfs the web, machine A calls up a program provided by the operator of the presently contemplated service. This program (e.g. a Java applet or plug-in to the machine's browser), sets up file transfer requests which are transmitted to and queued at transfer server 4. These requests contain information for locating files that are to be retrieved and stored by the transfer server. At its convenience, transfer server 4 interacts with FTP server 3 to retrieve files designated by the queued requests (see first horizontal line in FIG. 2), and stores the retrieved files. Typically, the information for locating a file to be retrieved is a URL (Uniform Resource Locator) that is associated either with the actual location of the file or the location of a web page containing a hyperlink to the file.

Upon identifying the file location (origin), the service's program running on machine A transmits a file retrieval request to transfer server 4; that request containing information indicating the location of a file to be retrieved and stored by server 4. The service program running on machine A, as presently contemplated, would run concurrent with the browser of that machine and perform its request transmissions in a manner transparent to the client's use of the Internet. In addition to URL information for locating files to be retrieved and stored, transmitted requests would contain sufficient information to identify the client and authenticate the client's identity (e.g. an ID and password as shown on the 2^{nd} horizontal line in FIG. 2). If a URL in a request is the effective address of a page containing one or more hyperlinks to downloadable files or other objects, retrieval of all of the linked objects is implied by the request and carried out by the transfer server.

As noted earlier, transmitted file retrieval requests of authorized clients are queued at transfer server 4, and at a time convenient to it server 4 connects to the file origin (FTP server) 3, and retrieves and stores the requested file(s) as suggested on the 3^{rd} horizontal line in FIG. 2. Retrieved files are stored at transfer server 4 in association with file names, and confirmation(s) of retrieval indicating these names is/are communicated to the client; e.g. by e-mail message(s) as noted on the 4^{th} horizontal line in FIG. 2. The stored file(s) is/are then available for subsequent access by the client (5^{th} horizontal line, FIG. 2); or for access by an associate of the client if, for example, the subscription to the service lists more than one individual as either the client or authorized associates of a client.

As shown in FIG. 1, communications from machines A and B to the transfer server represent different types of requests respectively designated “request A” and “request B”. Request A is a file retrieval request and request B is a file transfer request. As noted above, a file retrieval request calls for the transfer server to retrieve and store one or more files from a source specified in the request (e.g. FTP server 3), and to notify machine A of completion of these functions. Request B is a file transfer request that calls for transfer server 4 to transmit to the requesting workstation a file previously stored at server 4.

In the configuration of FIG. 1, machines A and B are used by the same client (at different times), in the following manner. Typically, machine A is a computer having a slow link to the internet (e.g. a laptop machine with a conventional modem being used by the client on a business trip) and machine B is a computer having a high speed link to the internet (e.g. a home desktop computer connecting to the internet via broadband cable or telephone system DSL). Assume then that while using machine A the client locates a large file that the client wants to download, but which is too large to be directly downloaded to machine A considering the speed of that machine's connection and the memory available on it. The client then signals the service program to send a file retrieval request to transfer server 4; e.g. by clicking on a (not shown) “file retrieval” icon displayed by that program. The service program then picks up the URL of the page currently being viewed by the browser in machine A, forms a file retrieval request, and transmits that request to transfer server 4. Server 4 queues the request, and at its convenience connects to the file source and retrieves and stores the requested file(s), Upon completing these functions, server 4 notifies the client (e.g. via an e-mail message), that notification indicating the name(s) of the stored file(s).

Later, after receiving the notification message and while using machine B, the client operates the service program at that machine to send a file transfer request to server 4, e.g. by clicking on a not shown “file transfer” icon displayed by that program. The name of the file to be transferred is incorporated in that request (preferably, by being picked up automatically from the confirmation message, but optionally by manual input from the client to the service program). In response, server 4 transmits the requested file, at a speed commensurate with the capabilities of the connection between machine B and the internet (which speed could be indicated to the transfer server either in the transfer request or by other prior communication(s) between machine B and server 4. Accordingly, the requested file, which could not be handled efficiently at machine A, is efficiently downloaded to machine B.

Another application of the foregoing service is as follows. Assume that machines A and B in FIG. 1 are a single multitasking computer used by a single client, and that at the time the client locates a file to be downloaded, computer A is busy with other tasks that would be unduly delayed by the downloading process. In this situation, computer A is operated to send a file retrieval request to transfer server 4, offloading the file retrieval process from the currently busy computer A. Later, when computer A is in a not busy state, and the client has received completion notification from server 4, computer A (now operating as the functional equivalent of machine B in FIG. 1) is operated to send a file transfer request to server 4 and the requested file is transmitted to computer A. In this instance, it may be assumed that computer A has the (speed) capability to directly download the requested file but does not use that capability when the download process could interfere with other functions currently being performed by the computer. Those skilled in the art will recognize that this use of the present transfer service would be desirable in many situations, including those wherein a computer is being used as part of a peer network shared by many disparate computers, as an expedient to avoid interference at one machine between file downloading functions and other functions.

Other applications of the presently contemplated transfer service, useful in networks having restrictions on movement of data (e.g. local networks protected by firewall objects), are suggested in FIGS. 3-5. In these applications, a transfer server operated by the transfer service is used to legitimately circumvent the restrictions. In each of the following examples, a transfer server operates between client workstations and remote sources of data external to a firewall to provide data retrieval, storage and transfer functions, where the firewall is effective to prevent direct transfer of data to workstations that are destinations of the transfer functions. As in the previously described applications, the data retrieval and storage functions are performed by the transfer server in response to data retrieval requests from client workstations, and the transfer functions are performed in response to data transfer requests from client workstations.

A first application of this principle is described with respect to the configuration of FIG. 3; wherein one or more client machines 20 and a transfer server 21 are located in a region 22 protected by a firewall 23. Typically, the firewall is located between protected objects in region 22 and a network connecting that region to remote objects such as FTP server 24. Objects in region 22 are referred to as behind the firewall, and objects outside that region are said to be outside the firewall. In the illustrated configuration, FTP server 24 represents a source of data which a user of a client machine 20 wants to download, but is prevented from directly doing so by the presence of the firewall which allows only authorized objects like transfer server 21 to receive data from objects outside the firewall.

In this instance, the client user of machine 20 sends a retrieval request to transfer server 21, that request indicating the source 24 of data to be retrieved, and the transfer server operates through the firewall to connect to FTP server 24, retrieve a file (or files) effectively designated by the request, and store the retrieved file. Upon successful completion of these functions, the client user issuing the request is notified of that fact in a communication containing the retrieved file name(s). Since the client machine and transfer server typically would be connected on a local network, this notification communication could be a message sent directly to the client machine via that network. When the client machine has received that communication, and its user is prepared to receive the data, the client machine is operated as before to send a transfer request to the transfer server (e.g. via the local network connection previously mentioned), and the latter sends the stored data associated with the request to the client machine.

As noted earlier, the firewall and/or the transfer server could be configured to screen the retrieved data for inappropriate content; e.g. viruses, or materials otherwise disallowed by the enterprise maintaining the firewall (e.g. materials irrelevant to a business conducted by that enterprise). If improper content is detected, the client would be notified that the requested functions could not be successfully completed.

A second example/application of this (firewall circumvention) technique is described with reference to FIG. 4. In this example, client machine(s) 30 is/are in a region 31 protected by firewall 32, and both a transfer server 33 and FTP server 34 (the latter representing a remote source of data that a user of a machine 30 wants to retrieve) are outside the protected region. Firewall 32 is programmed to allow free communication between the transfer server and objects in the protected region, to allow browsing communication between the protected objects and external objects other than the transfer server, and to block data transfers from such other external objects to the protected objects.

Accordingly, computer 30 is operated to send a retrieval request to transfer server 33. Server 33 queues the request, as in the earlier applications, and at its convenience connects to the data source 34, and retrieves and stores requested data. As before, server 33 notifies the client of completion of these functions; in this instance, via either e-mail or a local network message, depending upon the type of connection between server 33 and firewall 32.

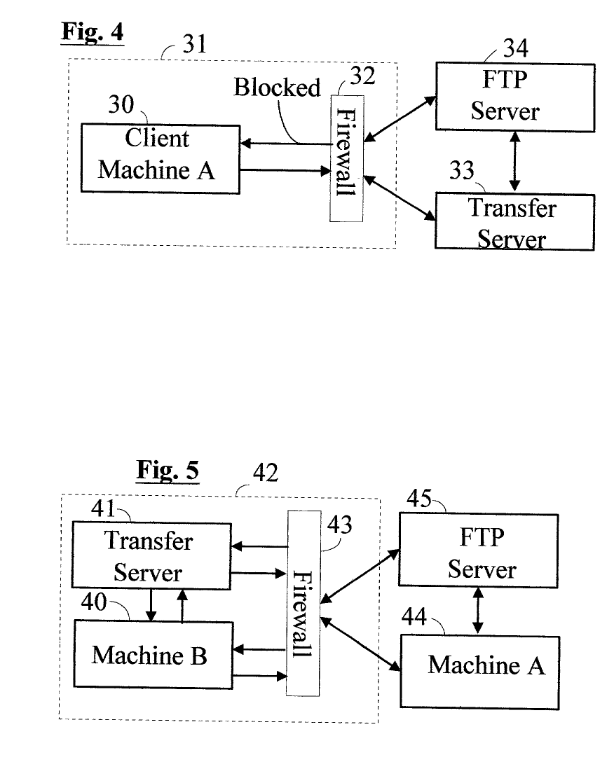

A third application/example is described relative to FIG. 5. Here, a client computer 40 (designated machine B) and transfer server 41 are in a region 42 protected by firewall 43, and another client computer 44 (designated machine A), used by the same client (or an associate sharing use of the transfer service), and remote source of data (FTP server) 45 are outside the protected region. In this instance, the user machine A locates data at 45 that the user would like to transfer to machine B, but is prevented from doing so directly by the presence of the firewall.

Accordingly, the user of machine A sends a retrieval request to transfer server 41, the latter being permitted by the firewall to receive data from external sources. In response, transfer server 41 connects to remote source 45, and retrieves and stores requested data. Upon completing these functions, server 41 notifies the requester. Subsequently, machine B is operated (by the same user or an authorized associate) to issue a transfer request in response to which server 41 transfers the stored data to machine B.

In some instances, it may be appropriate to have machine B designated in the retrieval request as the eventual destination of the retrieved data; and in such instances the notification of completion should be sent to both machines A and B.

As before, it also may be appropriate for the transfer server and/or firewall to screen retrieved data for inappropriate content and take suitable action when such is found.

Functions described above as relevant to this invention can be realized in various forms; e.g. all hardware, all software, or combinations of both. Functions performed by software may be installed in client workstations in the form of computer programs (e.g. browser plug-ins or applets). Such programs can be installed either from computer readable storage media or through data networks like the internet.

Computer programs, in the presently intended context, are expressions in any language, code or notation, of sets of instructions which when executed by a computer (or equivalent device) cause the presently relevant functions to be performed.

Accordingly, we claim the following.

1. A system for providing a file retrieval, storage and forwarding service for a user of a data communication network, said system comprising:
a file transfer server connected to said network; said file transfer server communicating with said user to receive first and second different requests from at least one workstation operated by said user; said file transfer server including:
elements responsive to a said first request to retrieve a data file from a source on said network identified in the respective request, said source remote from both said user workstation and transfer server, said elements acting further to store the retrieved file for said user;
elements for confirming to said user retrieval and storage of said requested file; and
elements responsive to a said second request issued by said user to transmit said stored file to said user.

2. A system in accordance with claim 1 wherein said first request may be issued by said user when, due to conditions at said user's workstation, it is more convenient to said user to have said file retrieved and stored by said file server than to download said file directly to said user's workstation.

3. A system in accordance with claim 2 wherein said conditions at said user's workstation and the size of the requested file make it impractical for said user to directly download said requested file to said user's workstation.

4. A system in accordance with claim 2 wherein said conditions at said user's workstation involve execution of tasks more important than retrieval of the requested file, which tasks would be unduly impeded by direct downloading of the requested file to said user's workstation.

5. A system in accordance with claim 2 wherein said requested file is a large file, said user issues said first request from a first workstation operating at a slow transmission speed that makes it impractical for said user to directly download said requested file; and said user issues said second request from a second workstation operating at a fast transmission speed more conducive to efficient retrieval of the requested file.

6. A system in accordance with claim 2 wherein:
said user workstation at which said first request is issued lies behind a firewall which effectively prevents transfer of data directly from said remote source to the respective workstation, but does not prevent prevent transfer of data from said transfer server to the same workstation.

7. A system in accordance with claim 5 wherein both said transfer server and a workstation instantly operated by said user to issue said first request are behind said firewall and said remote source of data is outside said firewall.

8. A system in accordance with claim 5 wherein both said transfer server and a workstation operated by said user to issue said second request are situated behind said firewall, and wherein said remote source of data and another workstation operated by said user to issue said first request are situated outside said firewall.

9. A system in accordance with claim 5 wherein both the transfer server and a workstation operated by said user to issue said first request are behind said firewall, and said remote data source and another workstation operated by said user to issue said second request are outside said firewall.

10. A method of providing a data file retrieval, storage and forwarding service to a user of a data communication network, relative to a source of a data file remote from said user, said method comprising:
maintaining a transfer service facility connected to said network;
operating said facility to receive first and second requests at different times from workstations operated by said network user;
responding to said first request to retrieve a data file from said remote source via said network; the location of said source on said network being indicated in said first request;
storing said retrieved data file for said user; and
responding to said second request to transmit said stored data file to a workstation instantly operated by said user to issue said second request.

11. A method of providing a file retrieval, storage and delivery service in accordance with claim 9 wherein said first and second requests are issued by different workstations remote from each other, both operated by said user.

12. A method in accordance with claim 9 wherein said first and second requests are both issued by a single workstation operated by said user.

13. A method in accordance with claim 9 including the step, between responses to said first and second request, of notifying said user of successful completion of said retrieval and storing operations.

14. A method in accordance with claim 12 wherein said network is the Internet;
said workstation operated by said user to issue said first request employs a browser program to locate said remote data source; and said step of notifying said user of said successful completion comprises sending an e-mail message to said user containing said notification; and
said second request is issued by said user contingent upon receipt of said confirming message.

15. The method of claim 12 wherein said first and second requests are issued at said user workstations by service programs provided by said service; said service programs being configured to run concurrent with said browser program; whereby transmittal of said first request presents minimal interference to other data processes currently being executed at the workstation instantly operated by said user to issue said first request; and whereby processes executed at said workstation, other than said service programs and browser program, are minimally impeded by the transmittal of said first request.

16. The method of claim 12 wherein both said transfer server and a single said workstation issuing said first and second requests are behind a firewall; and said remote data file source is outside of said firewall; wherein said firewall is effective to prevent direct transmittal of said data file from said remote source to said single workstation, but ineffective to block transmittal of the same file from said source to said transfer server, and also ineffective to block transmittal of the same file from said transfer server to said single workstation.

17. The method of claim 12 wherein:
said first and second requests are issued respectively by first and second different workstations;
said transfer server and said second workstation are behind a firewall restricting communications between said network and both said second workstation and said transfer server; and
said first workstation and said remote source are outside said firewall.

18. The method of claim 12 wherein:
said first and second requests are respectively transmitted from different first and second workstations operated by said user;
said first workstation and said transfer server are behind a firewall effectively preventing direct transmission of said data file from said remote source to said first workstation, but permitting transmission of said data file from said remote source to said transfer server; and
said second workstation and said remote source are both outside said firewall.

19. A program for a client user of a network transfer service, said service operating a transfer server, in response to requests received from said client, to retrieve, store and forward data from sources specified in said requests, said program comprising:
elements for forming retrieval requests containing a network location from which data is to be retrieved;
elements for connecting a workstation used by said client to said transfer server;
elements for transmitting said retrieval requests to said transfer server;
elements for forming transfer requests indicating data stored at said transfer server which is to be forwarded to said client; and
elements for transmitting said transfer requests to said transfer server.

20. A program for a transfer server operated by a network transfer service, said transfer operating relative to a data transmission network to retrieve, store and forward data in behalf of client users of said transfer service; said program comprising:
elements responsive to retrieval requests received from said client users to retrieve and store data for respective client users; said retrieval requests specifying network locations at which respective data is to be retrieved;
elements operating on completing retrieval and storage of data specified in said retrieval requests for transmitting notification communications to respective said client users; and
elements responsive to transfer requests received from said client users for forwarding data stored in response to prior retrieval requests to respective client users.
